(19) United States
(12) Patent Application Publication
(10) Pub. No.: US 2026/0237216 A1
(43) Pub. Date: Aug. 13, 2026

(54) WORK RECOGNITION DEVICE AND WORK RECOGNITION METHOD

(71) Applicant: TOYOTA JIDOSHA KABUSHIKI KAISHA, Toyota-shi (JP)

(72) Inventor: Natsuki FUJII HIROTA, Nagakute-shi (JP)

(73) Assignee: TOYOTA JIDOSHA KABUSHIKI KAISHA, Toyota-shi (JP)

(21) Appl. No.: 19/468,559

(22) Filed: Feb. 3, 2026

(30) Foreign Application Priority Data
Feb. 7, 2025 (JP) 2025-019288
Oct. 1, 2025 (JP) 2025-165466

(51) Int. Cl. G06V 20/52; G01L 5/00; G06V 10/764; G06V 40/10

(52) U.S. Cl. CPC G06V 20/52; G01L 5/0028; G06V 10/764; G06V 40/10

(57) ABSTRACT

A work recognition device that recognizes a work of a worker includes: a posture detection unit configured to detect a posture of the worker; an object information acquisition unit configured to acquire object information that is information regarding an object gripped by the worker; and a work identification unit configured to identify the work of the worker by using the posture and the object information.

### CROSS REFERENCE TO RELATED APPLICATIONS

This application claims the benefit of priority to Japanese Patent Application No. 2025-19288, filed on February 7, 2025, and Japanese Patent Application No. 2025-165466, filed on October 1, 2025, the contents of which are incorporated herein by reference in their entirety.

### BACKGROUND

### Field

The present disclosure relates to a work recognition device and a work recognition method.

### Related Art

A technology has been disclosed that estimates the posture of a worker by using sensors attached to the clothing of the worker in the Japanese Patent Application Publication No. 2022-148816.

In addition to estimating the posture of the worker, there is a demand to recognize a work being performed by the worker. However, it is often difficult for the sensor attached on the worker’s clothing to detect the state of the worker’s hands. Therefore, the accuracy in recognizing the work of the worker may be reduced.

### SUMMARY

According to one aspect of the present disclosure, a work recognition device is provided for recognizing a work of a worker. The work recognition device includes: a posture detection unit configured to detect a posture of the worker; an object information acquisition unit configured to acquire object information that is information regarding an object gripped by the worker; and a work identification unit configured to identify the work of the worker by using the posture and the object information.

### BRIEF DESCRIPTION OF THE DRAWINGS

FIG. 1 is a diagram showing a schematic configuration of a work recognition device in a first embodiment;

FIG. 2 is a flowchart showing a processing procedure of a work recognition process in the first embodiment;

FIG. 3 is a flowchart showing a processing procedure of a work recognition process in a second embodiment;

FIG. 4 is an explanatory diagram for explaining a skeleton graph and an extended skeleton graph in the second embodiment; and

FIG. 5 is a flowchart showing a processing procedure of a work recognition process in a third embodiment.

### DETAILED DESCRIPTION

### A. First Embodiment

### A1. Configuration of Work Recognition Device 100

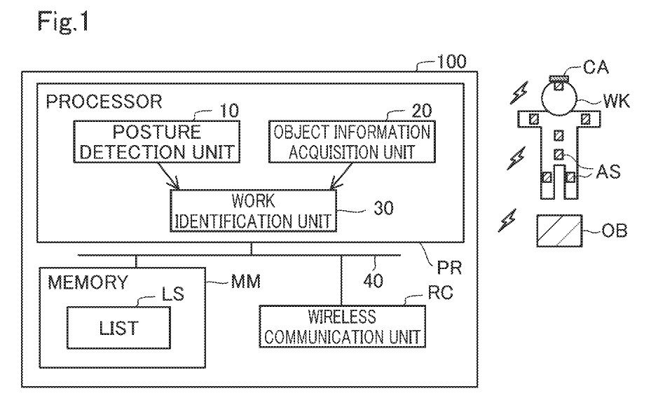

FIG. 1 is a diagram showing a schematic configuration of a work recognition device 100 in a first embodiment. The work recognition device 100 is used to recognize a work performed by a worker WK. The work recognition device 100 is used, for example, in a factory for manufacturing vehicles. The work performed by the worker WK refers to a work that the worker WK performs while gripping an object OB, and includes works related to assembly and installation of vehicle components. The object OB is, for example, a component to be assembled or installed, or a tool used during the assembly or installation process.

Posture sensors AS and a camera CA are attached to the worker WK. The posture sensors AS and the camera CA are configured to mutually communicate with the work recognition device 100 via a wireless Local Area Network (LAN). Posture sensor data acquired by the posture sensors AS and captured images captured by the camera CA are transmitted to the work recognition device 100 via the wireless LAN. The work recognition device 100 recognizes the work of the worker WK by using the posture sensor data and the captured images. Note that the posture sensors AS and the camera CA do not need to communicate with the work recognition device 100 via the wireless LAN, but may also communicate with the work recognition device 100 by any other wireless communication method such as Bluetooth® or via a wired LAN.

The posture sensors AS acquire the posture sensor data necessary for detecting the posture of the worker WK. A plurality of posture sensors AS is attached to the worker WK at multiple locations suitable for detecting the posture of the worker WK, such as joints and extremities. In the first embodiment, the expression “posture sensor data necessary for detecting the posture of the worker WK” includes information regarding position coordinates of the locations where the posture sensors AS are attached. Note that the posture sensors AS are not limited to sensors that acquire the sensor data including information regarding the position coordinates. The posture sensors AS may include various types of sensors capable of acquiring any sensor data, such as a gyro sensor, an acceleration sensor, a vibration sensor, a pressure sensor, and a sound sensor. The posture sensors AS are attached to the surface of the clothing of the worker WK, but all or some of them may alternatively be embedded in the clothing.

The camera CA captures the image of the object OB gripped by the worker WK, thereby acquiring the captured image. The camera CA is configured as a wearable camera that is worn on the body of the worker WK to capture images in a hands-free manner. More specifically, the camera CA is configured as a so-called First Person View (FPV) camera, which is worn on the head of the worker WK and used to acquire images from the first-person viewpoint of the worker WK.

The work recognition device 100 includes a computer that includes a processor PR, a memory MM, and a wireless communication unit RC. The processor PR, memory MM, and wireless communication unit RC are connected via an internal bus 40 to be able to communicate bidirectionally. The wireless communication unit RC receives the posture sensor data transmitted from the posture sensors AS and the captured image data transmitted from the camera CA. The memory MM stores, in advance, a list LS to be mentioned later, for identifying the type of the work of the worker WK. By executing a program stored in advance in the memory MM, the processor PR functions as a posture detection unit 10, an object information acquisition unit 20, and a work identification unit 30.

The posture detection unit 10 detects the posture of the worker WK by using the posture sensor data acquired by the posture sensors AS attached to the worker WK. The details of the processing performed when the posture of the worker WK is detected will be described later.

The object information acquisition unit 20 acquires object information, which is information regarding the object OB gripped by the worker WK, by using the captured image that has been captured by the camera CA attached to the worker WK. The object information acquired by the object information acquisition unit 20 includes various types of information regarding the object OB. In the first embodiment, the object information includes information regarding the type of the object OB. The details of the processing performed when the object information is acquired will be described later.

The work identification unit 30 identifies the work of the worker WK by using the posture of the worker WK detected by the posture detection unit 10 and the object information acquired by the object information acquisition unit 20. The details of the processing performed when the work of the worker WK is identified will be described later.

### A2. Work Recognition Process

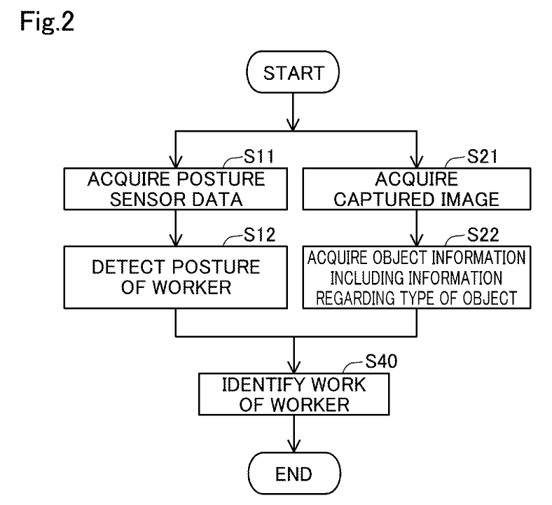

FIG. 2 is a flowchart showing a processing procedure of a work recognition process in the first embodiment. The term “work recognition process” means a process for the work recognition device 100 to recognize the work of the worker WK. The process described above is started when the worker WK or a supervisor of the worker WK gives an instruction to the work recognition device 100 to execute the work recognition process.

In step S11, each posture sensor AS attached to the clothing of the worker WK acquires posture sensor data. The posture sensor data includes information regarding the position coordinates of the locations where the posture sensors AS are attached. The wireless communication unit RC receives the posture sensor data transmitted from the posture sensors AS.

In step S12, the posture detection unit 10 detects the posture of the worker WK by using the posture sensor data acquired by the posture sensors AS. The posture of the worker WK is estimated by using a machine learning model stored in advance in the memory MM. Such a machine learning model has been trained in advance using teacher data that associates the posture sensor data from the posture sensors AS with the posture of the worker WK. The posture detection unit 10 detects, as the posture of the worker WK, the posture estimated by the machine learning model. In the present disclosure, a neural network is used as the machine learning model. The neural network is, for example, a Convolutional Neural Network (CNN), but may also include various types of machine learning models such as a Recurrent Neural Network (RNN).

In step S21, the camera CA captures an image of the object OB gripped by the worker WK, thereby acquiring a captured image. The wireless communication unit RC receives the captured image data transmitted from the camera CA.

In step S22, the object information acquisition unit 20 acquires object information about the object OB gripped by the worker WK by using the captured image of the object OB that has been captured by the camera CA. The object information acquired by the object information acquisition unit 20 includes information regarding the type of the object OB. The type of the object OB is estimated using a machine learning model stored in advance in the memory MM. Such a machine learning model has been trained in advance using teacher data that associates the captured image of the object OB with the type of the object OB. The object information acquisition unit 20 acquires, as the type of the object OB gripped by the worker WK, the type of the object OB estimated by the machine learning model.

In step S40, the work identification unit 30 identifies the work of the worker WK by using the posture of the worker WK detected by the posture detection unit 10 and the object information acquired by the object information acquisition unit 20. The object information includes information regarding the type of the object OB. As mentioned above, the memory MM stores, in advance, the list LS for identifying the type of the work of the worker WK. In the list LS, the type of the work of the worker WK corresponding to a combination of the posture of the worker WK and the type of the object OB is stored in advance. For example, the work “fastening a screw” is associated with a combination of the posture in which the worker WK is bending forward and the type of the object OB that includes a screw and a driver tool. The work identification unit 30 identifies the work being performed by the worker WK based on such a list LS.

According to the work recognition device 100 described above, the work identification unit 30 identifies the work of the worker WK by using both the posture of the worker WK and the object information that is the information regarding the object OB gripped by the worker WK. Thus, the work identification unit 30 is able to identify the work of the worker WK by taking into consideration not only the posture of the worker WK but also the object information. This enables the work of the worker WK to be recognized with high accuracy.

Furthermore, the object information acquisition unit 20 acquires the object information by using the captured image of the object OB captured with the camera CA, which is configured to capture images of the object OB gripped by the worker WK. This makes it possible to acquire, in real time, the object information regarding the object OB gripped by the worker WK. Thus, the object information with higher accuracy is able to be acquired as compared with a case where object information stored in advance in a memory or the like is acquired.

In addition, since the object information acquired by the object information acquisition unit 20 includes the information regarding the type of the object OB, the work identification unit 30 is able to identify the work of the worker WK by taking into consideration the type of the object OB gripped by the worker WK.

Furthermore, since the camera CA is configured as a wearable camera that acquires images from the first-person viewpoint of the worker WK, it is possible to suppress a situation in which the object OB gripped by the worker WK is located in a blind spot of the camera CA, resulting in a failure in acquiring an image of the object OB.

### B. Second Embodiment

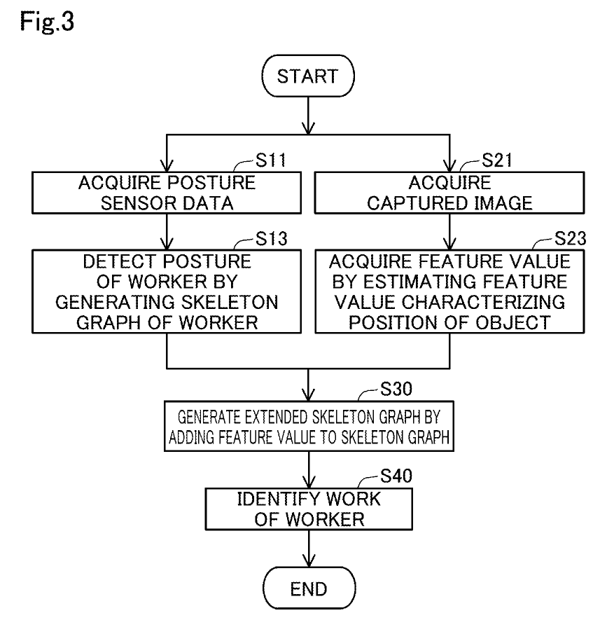

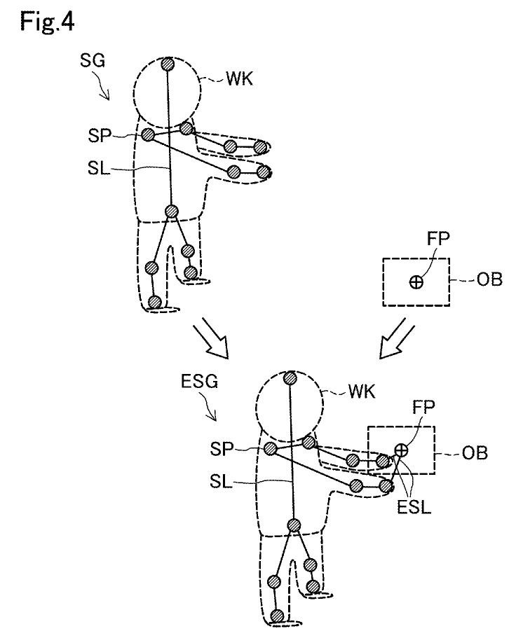

FIG. 3 is a flowchart showing a processing procedure of a work recognition process in a second embodiment. FIG. 4 is an explanatory diagram for explaining a skeleton graph SG and an extended skeleton graph ESG in the second embodiment. In the second embodiment, unlike the first embodiment, the work identification unit 30 identifies the work of the worker WK by using the extended skeleton graph ESG. For configurations and processing flows that are the same as those in the first embodiment, the same reference numerals are used, and detailed descriptions thereof are omitted.

After step S11, in step S13, the posture detection unit 10 detects the posture of the worker WK by generating the skeleton graph SG of the worker WK using the sensor data acquired by the posture sensors AS. The skeleton graph SG in the present disclosure refers to a graph representing the skeleton of the worker WK. The skeleton graph SG is generated, for example, by a Graph Convolutional Network (GCN) that applies a convolutional neural network to graph data.

As shown in FIG. 4, the skeleton graph SG includes a plurality of skeleton points SP and a plurality of skeleton lines SL that connect the respective skeleton points SP to each other. Each skeleton point SP corresponds to a node in the graph data, while each skeleton line SL corresponds to an edge in the graph data. Each skeleton point SP in the skeleton graph SG corresponds to the position coordinates of the posture sensor AS attached to the worker WK. Each skeleton line SL is estimated using a machine learning model stored in advance in the memory MM. Such a machine learning model has been trained in advance using teacher data that associates the sensor data from the posture sensors AS with the skeleton of the worker WK. Thus, which skeleton points SP are connected by each skeleton line SL is estimated. The posture detection unit 10 generates the skeleton graph SG of the worker WK based on the respective skeleton points SP and the skeleton lines SL estimated by the machine learning model.

The posture detection unit 10 detects the posture of the worker WK by using the skeleton graph SG of the worker WK. The posture of the worker WK is estimated by using a machine learning model stored in advance in the memory MM. Such a machine learning model has been trained in advance using teacher data that associates the skeleton graph SG of the worker WK with the posture of the worker WK. The posture detection unit 10 detects, as the posture of the worker WK, the posture estimated by the machine learning model.

Note that the machine learning model used for detecting the posture of the worker WK by generating the skeleton graph SG is preferably a recurrent neural network, and more preferably a Long Short-Term Memory (LSTM), which is a type of the recurrent neural network. Thus, the posture detection unit 10 is able to detect the posture of the worker WK with higher accuracy because the posture of the worker WK is allowed to be detected using the skeleton graph SG that models the action of the worker WK, which changes over time.

After step S21, in step S23, the object information acquisition unit 20 acquires a feature value characterizing the position of the object OB gripped by the worker WK by estimating the feature value using the captured image of the object OB that has been captured by the camera CA. The expression “feature value characterizing the position of the object OB” in the second embodiment refers to the position of the center of gravity FP of the object OB, which is obtained from the outer contour shape of the object OB. The object information acquisition unit 20 acquires the position and outer contour shape of the object OB using the captured image of the object OB. The object information acquisition unit 20 estimates the position of the center of gravity FP of the object OB, which has been obtained from the outer contour shape of the object OB, as the position of the center of gravity FP of the object OB.

In step S30, the posture detection unit 10 generates an extended skeleton graph ESG by adding the above-described feature value, that is, the position of the center of gravity FP of the object OB, to the skeleton graph SG. As shown in FIG. 4, in the extended skeleton graph ESG, the center of gravity FP of the object OB is added to the skeleton graph SG generated in step S13. The center of gravity FP of the object OB is connected to the skeleton graph SG by extended skeleton lines ESL. The extended skeleton line ESL connects to any skeleton point SP by using the machine learning model stored in advance in the memory MM. For the same reason as described above, the LSTM is preferably used as the machine learning model for generating the extended skeleton graph ESG.

In step S40, the work identification unit 30 identifies the work of the worker WK by using the extended skeleton graph ESG. The work of the worker WK is estimated using the machine learning model stored in advance in the memory MM. Such a machine learning model has been trained in advance using teacher data that associates the extended skeleton graph ESG of the worker WK with the work of the worker WK. The work identification unit 30 identifies, as the work being performed by the worker WK, the work estimated by the machine learning model.

Accordingly, the work recognition device 100 described above exhibits the same effects as those of the first embodiment. In addition, the work identification unit 30 identifies the work of the worker WK by using the extended skeleton graph ESG, which is generated by adding the feature value characterizing the position of the object OB to the skeleton graph SG of the worker WK. Thus, the work identification unit 30 is able to identify the work of the worker WK by using the extended skeleton graph ESG that specifically represents the action of the worker WK.

### C. Third Embodiment

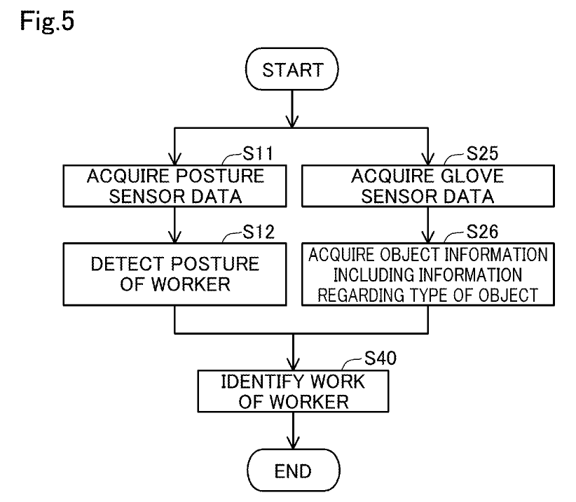

FIG. 5 is a flowchart showing a processing procedure of a work recognition process according to a third embodiment. In the third embodiment, unlike the first embodiment, the object information acquisition unit 20 acquires object information by using glove sensor data acquired by a glove sensor that is attached to the glove worn on the hand of the worker WK. For configurations and processing flows that are the same as those in the first embodiment, the same reference numerals are used, and detailed descriptions thereof are omitted.

In the present embodiment, the worker WK wears the glove with the glove sensor attached thereon, on one or both hands. The memory MM stores, in advance, the weight corresponding to the object OB of a predefined type. Such weight information is used when the object information acquisition unit 20 acquires the object information, as mentioned later.

In step S25, the glove sensor acquires glove sensor data. The glove sensor is attached to the glove worn by the worker WK. The term “glove sensor data” refers to the sensor data acquired by the glove sensor. The glove sensor data in the present embodiment includes pressure data acquired based on pressure applied to the glove sensor from the object OB gripped by the worker WK. More specifically, when the worker WK grips or holds the object OB, a reaction force corresponding to the pressing force of the fingers or hand of the worker WK against the object OB is applied to the glove sensor. The glove sensor detects this reaction force as the pressure. The glove sensor may be attached to the surface of the glove worn by the worker WK or embedded inside the glove.

In step S26, the object information acquisition unit 20 acquires the object information by using the glove sensor data. More specifically, the object information acquisition unit 20 first estimates the weight of the object OB gripped by the worker WK by using the glove sensor data. Next, the object information acquisition unit 20 refers to both the estimated weight of the object OB and the weight corresponding to the object OB stored in the memory MM, thereby acquiring the object information including the information regarding the type of the object OB.

Accordingly, the work recognition device 100 described above exhibits the same effects as those of the first embodiment. In addition, the object information is acquired using the data acquired by the glove sensor, which may omit the camera CA configured to capture images of the object OB when the work of the worker WK is identified. Furthermore, the object information is still able to be acquired even in a situation where the camera CA cannot detect the object OB because the object OB is located in the blind spot of the camera CA.

Moreover, since the glove sensor data includes the pressure data, the object information is able to be acquired using the pressure data.

### D. Other Embodiments

(D1) In the first and second embodiments, the posture detection unit 10 detects the posture of the worker WK by using the sensor data acquired by the posture sensors AS. However, the present disclosure is not limited thereto. For example, the posture detection unit 10 may detect the posture of the worker WK or generate the skeleton graph SG or extended skeleton graph ESG by using captured images that have been captured by a fixed camera.

(D2) In the first and second embodiments, the object information acquisition unit 20 acquires the object information on the object OB gripped by the worker WK by using the captured images that have been captured by the camera CA. However, the present disclosure is not limited thereto. For example, the object information acquisition unit 20 may acquire the object information by using object information stored in advance in the memory MM or object information stored in a server or the like.

(D3) In the first and second embodiments, the camera CA is configured as a wearable camera that acquires the images from the first-person viewpoint of the worker WK. However, the present disclosure is not limited thereto. For example, the camera CA may include one or more cameras CA fixed at a workspace of the worker WK.

(D4) In the first embodiment, the work identification unit 30 identifies the work being performed by the worker WK based on the list LS for identifying the type of the work of the worker WK. However, the present disclosure is not limited thereto. The work of the worker WK may be estimated using a machine learning model stored in advance in the memory MM. Such a machine learning model has been trained in advance, for example, using teacher data that associates the posture of the worker WK and the type of the object OB with the work of the worker WK. The work identification unit 30 may identify, as the work being performed by the worker WK, the work estimated by such a machine learning model.

(D5) In the first embodiment, the object information acquisition unit 20 acquires the information regarding the type of the object OB gripped by the worker WK, whereas in the second embodiment, the object information acquisition unit 20 acquires a feature value characterizing the position of the object OB gripped by the worker WK by estimating the feature value. However, the present disclosure is not limited thereto. The object information acquisition unit 20 may acquire various types of information regarding the object OB gripped by the worker WK, including the material, composition, and mass distribution of the object OB.

(D6) In the second embodiment, the posture detection unit 10 generates the extended skeleton graph ESG by adding the position of the center of gravity FP of the object OB to the skeleton graph SG. However, the present disclosure is not limited thereto. The posture detection unit 10 may add, to the skeleton graph SG, any elements regarding the object OB, such as any two or more points characterizing the object OB, the outer contour of the object OB, and a region surrounded by the outer contour of the object OB.

(D7) In the second embodiment, the object information acquisition unit 20 estimates the position of the center of gravity FP of the object OB gripped by the worker WK, which has been obtained from the outer contour shape of the object OB, as the position of the center of gravity FP of the object OB. However, the present disclosure is not limited thereto. The object information acquisition unit 20 may estimate information regarding the mass distribution of the object OB gripped by the worker WK and then may estimate the position of the center of gravity FP of the object OB by taking into account the mass distribution of the object OB.

(D8) In the first and second embodiments, the machine learning model has been trained in advance by supervised learning using the teacher data. However, the present disclosure is not limited thereto. The machine learning model may be trained through unsupervised learning or reinforcement learning.

(D9) In the first and second embodiments, the neural network is used as the machine learning model. However, the present disclosure is not limited thereto. Instead of the neural network, another machine learning model such as a support vector machine or a random forest may be used.

(D10) In the third embodiment, the glove sensor data acquired by the glove sensor includes the pressure data acquired based on the pressure applied to the object OB through the glove worn by the worker WK. However, the present disclosure is not limited thereto. The glove sensor data may include, in place of or in addition to the pressure data, various types of data, such as data regarding the motion of the hand and fingers of the worker WK, data regarding the bending degree of finger joints thereof, data regarding the spatial position of the hand, and data regarding the temperature of the object OB. Such various types of data may then be used to acquire the object information.

(D11) In the third embodiment, the object information acquisition unit 20 acquires the object information by referring to the estimated weight of the object OB and the weight corresponding to the object OB stored in the memory MM. However, the present disclosure is not limited thereto. The object information acquisition unit 20 may acquire the object information by using a machine learning model stored in advance in the memory MM. The machine learning model may be trained in advance using teacher data that associates the glove sensor data acquired by the glove sensor with the object information.

The present disclosure is implementable in various forms other than the embodiments of the work recognition device 100, such as a work recognition method and a computer program.

The present disclosure is not limited to the above-described embodiments, and may be implemented in various configurations without departing from the spirit of the disclosure. For example, the technical features described in the embodiments, which correspond to the technical features of the aspects described in the Summary of the Invention section, may be replaced or combined with other technical features as appropriate, in order to solve part or all of the above-described problems or to achieve part or all of the above-described advantages. Further, unless a technical feature is described herein as being essential, it may be omitted as appropriate. For example, the present disclosure may be implemented in aspects described below.

(1) According to one aspect of the present disclosure, a work recognition device is provided to recognize a work of a worker. The work recognition device includes: a posture detection unit configured to detect a posture of the worker; an object information acquisition unit configured to acquire object information that is information regarding an object gripped by the worker; and a work identification unit configured to identify the work of the worker by using the posture and the object information. According to this aspect, the work identification unit identifies the work of the worker by using both the posture of the worker and the object information, which is information regarding the object gripped by the worker. Thus, the work identification unit is able to identify the work of the worker by taking into consideration not only the posture of the worker but also the object information. Therefore, the work of the worker is able to be recognized with high accuracy.

(2) In the above-described aspect, the object information acquisition unit may acquire a captured image of the object gripped by the worker, from a camera configured to capture the image of the object, and may acquire the object information by using the captured image. According to this aspect, the object information acquisition unit acquires the object information by using the captured image of the object gripped by the worker, which has been captured by the camera configured to capture the image of the object. Thus, the object information about the object gripped by the worker is able to be acquired in real time. Therefore, the object information with higher accuracy is able to be acquired as compared with a case where object information stored in advance in a memory or the like is acquired.

(3) In the above-described aspect, the object information acquired by the object information acquisition unit may include information regarding a type of the object. According to this aspect, since the object information acquired by the object information acquisition unit includes information regarding the type of the object, the work identification unit is able to identify the work of the worker by taking into consideration the type of the object gripped by the worker.

(4) In the above-described aspect, the object information acquired by the object information acquisition unit may include a feature value characterizing a position of the object, the object information acquisition unit may acquire the feature value by estimating the feature value from the captured image, the posture detection unit may generate a skeleton graph of the worker in the posture and may generate an extended skeleton graph by adding the feature value to the skeleton graph, and the work identification unit may identify the work of the worker by using the extended skeleton graph. According to this aspect, the work identification unit identifies the work of the worker by using the extended skeleton graph, which is generated by adding the feature value characterizing the position of the object to the skeleton graph of the worker. Thus, the work identification unit is able to identify the work of the worker by using the extended skeleton graph that specifically represents the action of the worker.

(5) In the above-described aspect, the camera may be configured as a wearable camera that acquires an image from a first-person viewpoint of the worker. According to this aspect, since the camera is configured as the wearable camera that acquires images from the first-person viewpoint of the worker, it is possible to suppress a situation in which the object gripped by the worker is located in a blind spot of the camera, resulting in a failure in acquiring an image of the object.

(6) In the above-described aspect, the object information acquisition unit may acquire the object information by using glove sensor data acquired by a glove sensor that is attached to a glove worn by the worker. According to this aspect, the object information is acquired using data acquired by the glove sensor, which may omit the camera configured to capture images of the object when the work of the worker is identified. Furthermore, the object information is still able to be acquired even in a situation where the camera cannot detect the object because the object is located in the blind spot of the camera.

(7) In the above-described aspect, the glove sensor data may include pressure data acquired based on pressure applied to the object through the glove. According to this aspect, since the glove sensor data includes the pressure data, the object information is able to be acquired using the pressure data.

What is claimed is:

1. A work recognition device for recognizing a work of a worker, comprising:
a posture detection unit configured to detect a posture of the worker;
an object information acquisition unit configured to acquire object information that is information regarding an object gripped by the worker; and
a work identification unit configured to identify the work of the worker by using the posture and the object information.

2. The work recognition device according to claim 1, wherein the object information acquisition unit acquires a captured image of the object gripped by the worker, from a camera configured to capture the image of the object, and acquires the object information by using the captured image.

3. The work recognition device according to claim 2, wherein the object information acquired by the object information acquisition unit includes information regarding a type of the object.

4. The work recognition device according to claim 2, wherein
the object information acquired by the object information acquisition unit includes a feature value characterizing a position of the object,
the object information acquisition unit acquires the feature value by estimating the feature value from the captured image,
the posture detection unit generates a skeleton graph of the worker in the posture and generates an extended skeleton graph by adding the feature value to the skeleton graph, and
the work identification unit identifies the work of the worker by using the extended skeleton graph.

5. The work recognition device according to claim 2, wherein the camera is configured as a wearable camera for acquiring an image from a first-person viewpoint of the worker.

6. The work recognition device according to claim 1, wherein the object information acquisition unit acquires the object information by using glove sensor data acquired by a glove sensor attached to a glove worn by the worker.

7. The work recognition device according to claim 6, wherein the glove sensor data includes pressure data acquired based on pressure applied to the glove sensor from the object.

8. A method for recognizing a work of a worker, comprising:
detecting a posture of the worker;
acquiring object information that is information regarding an object gripped by the worker; and
identifying the work of the worker by using the posture and the object information.
